(19) United States
(12) Patent Application Publication
(10) Pub. No.: US 2008/0273692 A1
(43) Pub. Date: Nov. 6, 2008

(54) Telephone Having Multiple Headset Connection Capability

(76) Inventor: George T. Buehl, West Long Branch, NJ (US)

Correspondence Address: DUANE MORRIS LLP - Princeton, PO BOX 5203, PRINCETON, NJ, 08543-5203, US

(21) Appl. No.: 11/744,190

(22) Filed: May 3, 2007

(51) Int. Cl. H04M 1/03

(52) U.S. Cl. 379/428.02

(57) ABSTRACT

A telephone including a base having a plurality of telephone headset connections, each of the headset connections for connecting a telephone headset to the telephone.

### FIELD OF INVENTION

The invention relates to telephones, and more particularly, to telephone having multiple headset connection capability.

### BACKGROUND OF THE INVENTION

Telephones operating on single or multiple line systems, or in conference arrangements are well known in the art. Some of these telephones utilize two or more handsets to allow two or more users at one location to talk on a single or multiple telephone lines and are used in many applications including, without limitation, teleconferencing applications and translation applications.

Telephone headsets permit the use of a telephone microphone and earphone while freeing the user's hands for other activities such as note taking and computer keyboard entry. A typical headset may include an ear support portion which rests on the ear of a user and positions an earphone against the ear of the user, and a microphone at the end of a boom attached to the ear support. Alternatively, the microphone may be positioned within the ear support and sound brought to it from the user's mouth by way of a hollow boom.

Although some existing telephones allow the connection of a single headset, there are no telephones that are capable of connecting multiple headsets. A telephone with multiple headset connection capability would be desirable where both users want to handle papers or write while the conversation proceeds. For example, such a telephone would be desirable in a hospital setting by a patient and doctor where the doctor may need to take notes and the patient may have difficulty holding a handset due to illness, injury, attached medical equipment, or the effects of medication.

Accordingly, a need exists for a telephone with multiple headset connection capability.

### SUMMARY

Disclosed herein is a multiple headset telephone which comprises a base including a plurality of telephone headset connections, each of the headset connections for connecting a telephone headset to the telephone, at least two of the headset connections being capable of simultaneous use in a telephone call.

In one embodiment, the multiple headset telephone may further comprise a volume control for each of the headset connections, each of the volume controls for selectively adjusting a speaker volume of a telephone headset connected to the volume control's respective headset connection.

In another embodiment, the multiple headset telephone may also comprise a telephone headset for each of the headset connections. Each of the headsets may comprise a volume control for selectively adjusting a speaker volume of the headset.

In a further embodiment of the multiple headset telephone, each of the headset connections may comprise at least one of a wired connection, a jack connection, and a wireless connection.

Also disclosed herein is a telephone which comprises a base including a plurality of telephone handsets; and a plurality of telephone headset connections, each of the headset connections for connecting a telephone headset to the telephone, at least two of the headset connections being capable of simultaneous use in a telephone call.

In one embodiment, the headset connections and the handsets of the telephone are operatively paired with one another into a plurality of groups, each of the groups including one of the headset connections and one of the handsets.

In a further embodiment, the telephone further comprises a headset volume control for each of the headset connections, each of the headset volume controls for selectively adjusting a speaker volume of a telephone headset connected to the headset volume control's respective headset connection.

In a further embodiment, the telephone further comprises a handset volume control for each of the handsets, each of the handset volume controls for selectively adjusting a speaker volume of the handset volume control's respective handset.

In still a further embodiment, the telephone further comprises a telephone headset for each of the headset connections.

In one embodiment, each of the headsets of the telephone includes a volume control for selectively adjusting a speaker volume of the headset.

In yet a further embodiment, each of the headset connections of the telephone comprises at least one of a wired connection, a jack connection, and a wireless connection.

In an alternate embodiment of the telephone, each of the headset connection/handset groups includes a switch for automatically deactivating the handset of the group when the headset connection of the group is in use.

In another alternate embodiment of the telephone, each of the headset connection/handset groups includes a switch for automatically deactivating the headset connection of the group when the handset of the group is in use.

In a further alternate embodiment, the telephone further comprises a switch for allowing at least one of the plurality of headset connections to independently operate the telephone without the use of any of the plurality of handsets.

In yet a further alternate embodiment, the telephone further comprises a switch for allowing at least one of the plurality of handset connections to independently operate the telephone without the use of any of the plurality of headsets.

Further disclosed herein is a telephone which comprises a base including at least one telephone handset; and at least one telephone headset connection, the at least one headset connection for connecting a telephone headset to the telephone. The at least one headset connection and the at least one handset are operatively associated with one another so that the at least one headset connection and the at least one handset are capable of being simultaneously used in a telephone call.

Still further disclosed herein is a telephone which comprises a base including a plurality of telephone handsets; and at least one telephone headset connection, the at least one headset connection for connecting a telephone headset to the telephone. The at least one headset connection and the plurality of handsets are operatively associated with one another so that the at least one headset connection and any one of the plurality of handsets are capable of being simultaneously used in a telephone call.

Also disclosed herein is a telephone which comprises a base including a plurality of telephone handsets; and a plurality of telephone headset connections, each of the headset connections for connecting a telephone headset to the telephone; and a switching arrangement for allowing one or more of the headset connections and one or more of the handsets to be selected in any combination for simultaneous use in a telephone call.

Also disclosed herein is a telephone which comprises a base; a plurality of telephone handsets mounted on the base; and a handset volume control for each of the handsets, each of the handset volume controls for selectively adjusting a speaker volume of the handset volume control's respective handset.

### BRIEF DESCRIPTION OF THE DRAWINGS

FIG. 1 shows an embodiment of a telephone with multiple headset capability.

FIG. 2 shows an embodiment of a telephone with handset and headset capability.

FIG. 3 shows another embodiment of a telephone with handset and headset capability.

FIG. 4 shows one embodiment of a switching circuit.

In the drawings, the same numerals denote the same elements.

### DETAILED DESCRIPTION OF THE INVENTION

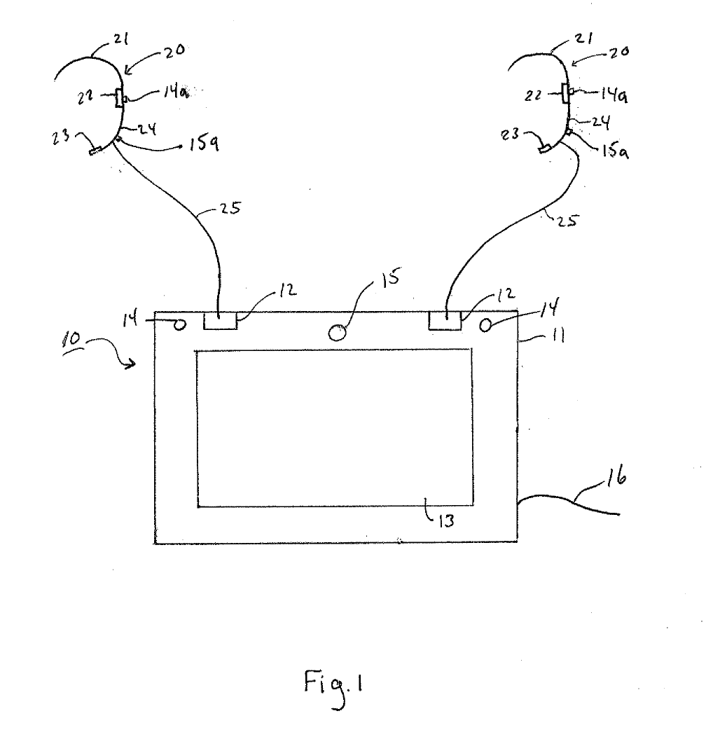

FIG. 1 shows an embodiment of a telephone with multiple headset capability, denoted generally by numeral 10. Telephone 10 comprises a telephone base 11 including two telephone headset connections 12 for respectively connecting telephone headsets 20 of any suitable design, a wired or jack external line connection 16 for connecting telephone 10 to an external telephone line, and a numerical keypad 13 or any other suitable mechanism for dialing telephone numbers. In other embodiments, telephone 10 may include additional headset connections 12 for respectively connecting additional headsets 20. The base 11 of the telephone 10 further includes any suitable ringing and telephonic operational circuitry including but not limited to audio and dialing circuits (not shown). In one embodiment of telephone 10, the ringing and telephonic operational circuitry may comprise circuitry similar to that described in U.S. Pat. No. 5,784,456, the entire disclosure of which is incorporated herein by reference.

In one embodiment of telephone 10, one or more of the headsets 20 may include a head support member 21 which rests on the head of a user and positions a speaker earphone 22 against an ear of the user, and a microphone 23 at the end of a boom 24 attached to the head support member 21. One or more of the headsets, in other embodiments, may include the microphone positioned adjacent to the head support member and sound brought to it from the user's mouth by way of a hollow boom (not shown). Further embodiments of the headsets may include an ear support member which rests on the eat of the user, for supporting the speaker earphone (now shown). One or more of the headsets may also include two speaker earphones, one for each of the user's ears (not shown).

In one embodiment of telephone 10, a volume control 14 is provided for each of the headsets 20. The volume controls 14 allow the users to selectively adjust the speaker volume of their respective telephone headset 20, independently of the other headset 20. The volume controls 14 may be provided on the base 11 where they selectively control the speaker volume of their respective headset 20, via their respective headset connection 12. Volume controls 14a may be locally provided on each of the headsets 20, in addition or alternatively to the volume controls 14 provided on the base 11.

In one embodiment of telephone 10, the headset connections 12 may be wired connections for non-removably connecting the headsets 20 with the base 11 by conventional coiled or non-coiled telephone cords 25. In another embodiment of telephone 10, the headsets connections 12 may be jack connections for removably connecting the headsets 20 with the base 11 by the coiled or non-coiled telephone cords 25, which in turn, include corresponding plug connectors (not shown) that plug into the jack connections 12. In yet another embodiment of telephone 10, the headsets connections 12 may be antenna connections for wirelessly connecting the headsets 20 with the base 11, wherein the headsets 20 are constructed with corresponding antennas (not shown) for transmitting and receiving signals to and from the antenna headset connections 12, which in turn, must be capable of transmitting and receiving signals to and from the antennas of the headsets 20. It is contemplated that telephone 10 may include any combination of the above described headset connections.

In one embodiment of telephone 10, the telephonic operational circuitry associated with the headset connections 12 allows the connected headsets 20 to be used at the same time. Thus, two or more users may communicate simultaneously over the same external telephone line using their respective headsets 20.

In another embodiment of telephone 10, a headset connection switch 15 is provided on the base 11 and associated with the telephonic operational circuitry for allowing one or more of the headset connections 12 and their respectively connected headsets 20 to be independently selected in any combination for connection with the same external telephone line. This assures that the headset 20 or headsets 20 connected to the unselected headset connections 12 are not connected with the headset 20 or headsets 20 that are in use and connected to the selected headset connections 12, thereby preventing detrimental effects, such as noise picked up by the unused connected headset or headsets, from interfering with the headset 20 or headsets 20 in use.

The headset connection switch 15 may include a mode that activates all the headset connections 12, thereby allowing all of the headsets 20 to be used at the same time.

In still other embodiments, the headsets 20 may be provided with headset connection switches 15a that are capable of activating or deactivating the unused headsets 20. Headsets including the headset connection switches 15a may be used with base 11 that includes the headset connection switch 15 or with a base (not shown) which does not include the headset connection switch 15.

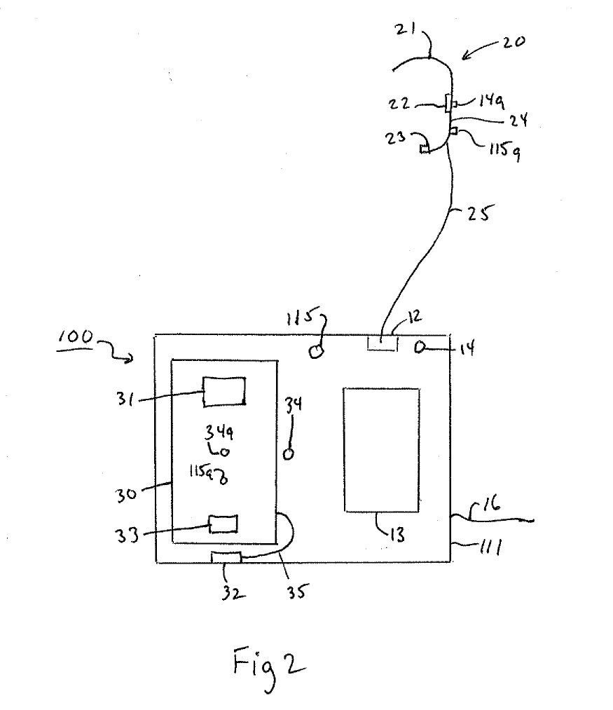

FIG. 2 shows an embodiment of a telephone with handset and headset capability, denoted generally by numeral 100. The telephone 100 comprises a telephone handset 30 of any suitable design including a speaker 31 and a microphone 33, a telephone base 111 including a telephone handset retaining cradle or equivalent handset retaining or holding structure (not shown) for retaining the handset 30, a telephone handset connection 32 for connecting the handset 30, a telephone headset connection 12 for connecting a telephone headset 20, a wired or jack external line connection 16 for connecting telephone 100 to an external telephone line, and a numerical keypad 13 or any other suitable mechanism for dialing telephone numbers. A second dialing keypad (not shown) may be located on the handset 30 in addition or alternatively to the keypad 13 on the base 111. Similar to telephone 10 shown in FIG. 1, the base 111 of the telephone 100 further includes any suitable ringing and telephonic operational circuitry (not shown), Moreover, the telephone headset connection 12 and telephone headset 20 may be constructed as described earlier with respect to FIG. 1.

In one embodiment of telephone 100, the handset connection 32 may be a wired connection for non-removably connecting the handset 30 with the base 111 by a conventional coiled or non-coiled telephone cord 35. Alternatively, the handset connection 32 may be a jack connection for removably connecting the handset 30 with the base 111 by the telephone cord 35, which correspondingly includes a plug connector (not shown) that plugs into the jack handset connection 32. In yet another embodiment of telephone 100, the handset connection 32 may be an antenna connection for wirelessly connecting the handset 30 with the base 1, wherein the handset 30 then includes a corresponding antenna (not shown) for transmitting and receiving signals to and from the antenna handset connection 32, which is capable of transmitting and receiving signals to and from the antenna of the handset 30. It is also contemplated that the telephone 100 may comprise any combination of the above described handset connections 32.

In one embodiment of telephone 100, a first volume control 14 is provided for selectively adjusting the speaker volume of the headset 20 and a second volume control 34 is provided for selectively adjusting the speaker volume of the handset 30. The volume controls 14 and 34 may be provided on the base 111 where they selectively control the speaker volume of their respective headset 20 and handset 30, via their respective headset connection 12 and handset connection 32. The headset 20 and the handset 30 may each be locally provided with respective volume controls 14a and 34a in addition or alternatively to the volume controls 14 and 34 provided on the base 111.

In one embodiment of telephone 100, the telephonic operational circuitry associated with the headset connection 12 and handset connection 32, allows the respectively connected headset 20 and connected handset 30 to be used at the same time. Thus, two users may communicate simultaneously over the same external telephone line using both the headset 20 and handset 30.

In another embodiment of telephone 100, a headset/handset connection switch 115 is provided on the base 111 and associated with the telephonic operational circuitry for allowing the headset and handset connections 12, 32 and their respectively connected headset and handset 20, 30, to be independently selected for connection with the same external telephone line. This assures that the unselected headset or handset connection 12, 32 and its respective headset 20 or handset 30 is not connected with the headset or handset connection 12, 30 and its respective headset 20 or handset 30 that is in use, thereby preventing detrimental effects, such as noise picked up by the unused headset 20 or handset 30, from interfering with the headset 20 or handset 30 that is in use.

It is contemplated that the headset/handset connection switch 115 may include a mode that activates both the headset and handset connections 12, 32, thereby allowing both the headset 20 and the handset 30 to be used at the same time.

In some embodiments, the headsets 20 and/or the handsets 30 may each be provided with a connection switch 115a that is each capable of activating or deactivating the unused headset 20 and/or handset 30. Headsets and handsets including the locally provided connection switches 115a may be used with base 111 that includes the headset/handset connection switch 115 or with a base (not shown) which does not include the headset/handset connection switch 115.

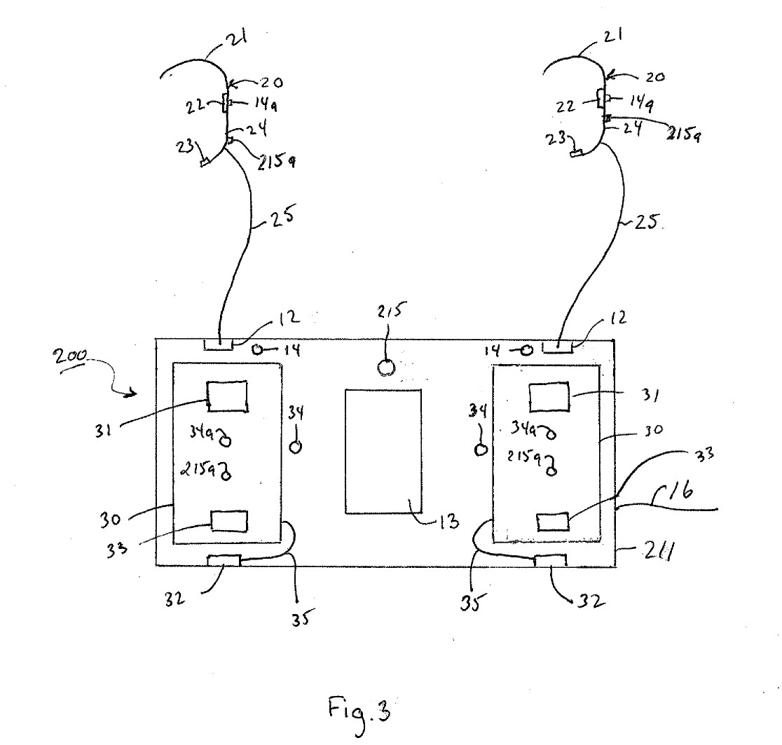

FIG. 3 shows an embodiment of a telephone with multiple headset and handset capability, denoted generally by numeral 200. The telephone 200 includes substantially the same features as telephone 100 described earlier with respect to FIG. 2, and in addition, includes two or more of the earlier described telephone handsets 30, a corresponding number of telephone handset retaining cradles or equivalent handset retaining or holding structures (not shown) formed in or otherwise associated with base 211 for retaining the handsets 30, two or more of the earlier described telephone handset connections 32 for connecting each of the handsets 30 with the base 211, and two or more of the earlier described telephone headset connections 12 for connecting two or more of the earlier described telephone headsets 20 with base 211.

In one embodiment of telephone 200, the headset connections 12 and the handset connections 32 are operatively paired with one another into two or more groups, each of the groups including one of the headset connections 12 and one of the handset connections 32.

In one embodiment of telephone 200, volume controls 14 and 34 are provided for selectively adjusting the speaker volume of the headsets 20 and handsets 30, independently (i.e., one volume 14 control for each headset 20 and one volume control 34 for each handset 30). The volume controls 14 and 34 may be provided on the base 211 where they selectively control the speaker volume of their respective headsets 20 and handsets 30, via their respective headset connections 12 and handset connections 32. The headsets 20 and the handsets 30 may each be locally provided with respective volume controls 14a and 34a in addition or alternatively to the volume controls 14 and 34 provided on the base 211.

In one embodiment of telephone 200, the telephonic operational circuitry associated with the headset connections 12 and handset connections 32, allows the respectively connected headsets 20 and handsets 30 to be used at the same time. Thus, multiple users may communicate simultaneously over the same external telephone line using both the headsets 20 and the handsets 30.

In another embodiment of telephone 200, a headset/handset connection switch 215 is provided on the base 21.1 and associated with the telephonic operational circuitry for allowing one or more of the headset and handset connections 12, 32 and their respectively connected headsets and handsets 20, 30, to be independently selected in any combination for connection with the same external telephone line. This assures that the unselected headset and/or handset connection(s) 12, 32 and their respective headset(s) 20 and handset(s) 30 are not connected with the headset and/or handset connection(s) 12, 30 and their respective headset(s) 20 and handset(s) 30 that is/are in use, thereby preventing detrimental effects, such as noise picked up by the unused headset(s) 20 and/or handset(s) 30, from interfering with the headset(s) 20 and/or handset(s) 30 that is/are in use.

It is contemplated that the headset/handset connection switch 215 may include a mode that activates all the headset and handset connections 12, 32, thereby allowing all of the headsets 20 and the handsets 30 to be used at the same time.

In some embodiments, the headsets 20 and/or the handsets 30 may each be locally provided with a connection switch 215a that is capable of activating or deactivating the unused headset(s) 20 and/or handset(s) 30. Headsets and handsets including the locally provided connection switches 215a may be used with base 211 that includes the headset/handset connection switch 215 or with a base (not shown) which does not include the headset/handset connection switch 215.

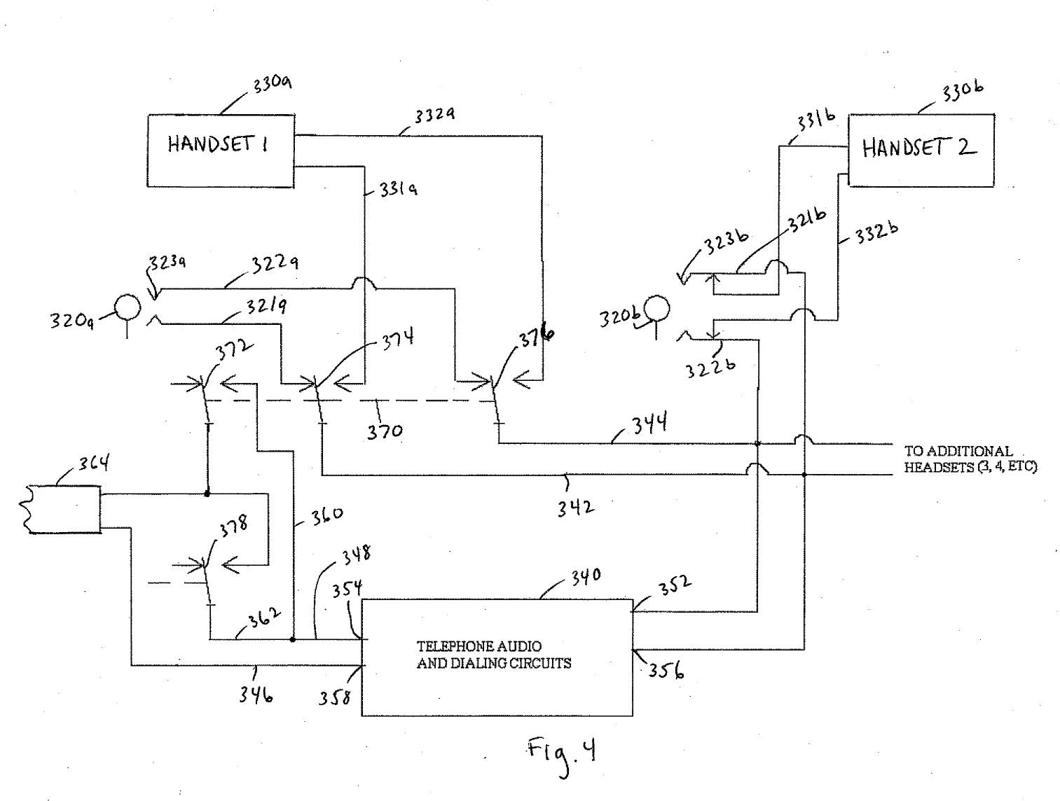

FIG. 4 shows one embodiment of a switching circuit that may be used with the telephones described herein. The switching circuit, generally denoted by reference numeral 300, includes first handset speaker and microphone connection lines 331a and 332a for connecting a first handset 330a, first headset speaker and microphone connection lines 321a and 322a for connecting a first headset 320a via first headset connection 323a, telephone audio and dialing circuits 340, audio receiving and transmission lines 342 and 344, and audio input and output lines 346 and 348. The audio transmission line 344 is connected to a first input 352 of telephone audio and dialing circuits 340 and the audio output line 348 is connected to a first output 354 of the telephone audio and dialing circuits 340. The audio receiving line 342 is connected to a second output 356 of the telephone audio and dialing circuits 340 and the audio input line 346 is connected to a second input 358 of the telephone audio and dialing circuits 340. The audio output line 348 is connected to first and second switched audio output lines 360 and 362, respectively. The input audio line 346 is connected to a telephone line 364.

The switching circuit 300 further includes a handset activated hookswitch 370 having first, second, third switching elements 372, 374, and 376. When the first handset 330a is used, the first, second, and third switching elements 372, 374, 376 of the hookswitch 370 operate to automatically connect the first handset 330a to the telephone audio and dialing circuits 340 and the telephone line 364 to enable telephonic operation of the first handset 330a and disconnect the first headset 320a from the telephone audio and dialing circuits 340 to disable telephonic operation of the first headset 320a, in the following manner. The first switching element 372 connects the first switched audio output line 360 to the telephone line 364. The second switching element 374 connects the first handset speaker connection line 331a to the audio receiving line 342 and disconnects the first headset speaker connection line 321a from the audio receiving line 342. The third switching element 376 connects the first handset microphone connection line 332a to the audio transmitting line 344 and disconnects the first headset microphone connection line 322a from the audio transmitting line 344.

When the first handset 330a is not used (handset off mode), the first, second, and third switching elements 372, 374, 376 of the hookswitch 370 operate to automatically disconnect the first handset 330a from the telephone audio and dialing circuits 340 and the telephone line 364 to disable telephonic operation of the first handset 330a and connect the first headset 320a to the telephone audio and dialing circuits 340 in preparation for telephonic operation of the first headset 320a in the following manner. The first switching element 372 disconnects the first switched audio output line 360 from the telephone line 364. The second switching element 374 connects the first headset speaker connection line 321a to the audio receiving line 342 and disconnects the first handset speaker connection line 331a from the audio receiving line 42. The third switching element 376 connects the first headset microphone connection line 322a to the audio transmitting line 344 and disconnects the first handset microphone connection line 332a from the audio transmitting line 344.

The first headset 320a may be used for telephonic operation in the handset off mode by activating a manual hookswitch 378 which connects the second switched audio output line 362 to the telephone line 364.

The switching circuit 300 additionally includes at least a second handset speaker connection line 331b and at least a second microphone connection line 332b for connecting at least a second handset 330b, and at least a second headset connection 323b including a second headset speaker connection line 321b and a second headset microphone line 322b for connecting at least a second headset 320b. The second headset connection 323b switchably connects the second handset speaker connection line 331b to the second headset speaker connection line 321b and switchably connects the second handset microphone line 332b to the second headset microphone connection line 322b. The second headset speaker connection line is connected to the audio receiving line 342 and the second headset microphone connection line 322b is connected to the audio transmitting line 344.

When the second headset 320b is disconnected from the second headset speaker connection 323b, the second handset speaker connection line 331b automatically connects to the second headset speaker connection line 321b, which is connected to the audio receiving line 342, and the second handset microphone connection line 332b automatically connects to the second headset microphone connection line 322b, which is connected to the audio transmitting line 344. Accordingly, the second handset 320b may be used concurrently with either the first handset 330a or first headset 320a (and additional headsets or handsets) to conduct a telephone call.

When the second headset 320b is connected to the second headset connection 323b, the second handset speaker connection line 331b automatically disconnects from the second headset speaker connection line 321b and is, therefore, no longer connected to the audio receiving line 342, and the second handset microphone connection line 332b automatically disconnects from the second headset microphone connection line 322b and is, therefore, no longer connected to the audio transmitting line 344. Consequently, the second handset speaker connection line 331b is no longer connected to the audio receiving line 342, and the second handset microphone connection line 332b is no longer connected to the audio transmitting line 344. Accordingly, only the second headset 320b may be used concurrently with either the first handset 330a or first headset 320a (and additional headsets or handsets) to conduct a telephone call, as the second headset speaker connection line 321b remains connected to the audio receiving line 342, and the second headset microphone connection line 322b remains connected to the audio transmitting line 344.

It should be understood that other embodiments of the switching circuit are contemplated herein. The specific design of such other embodiments will depend upon the desired headset/headset or handset/headset usage capability.

The invention is not limited to the embodiments described above. For example, the telephones may include additional components such as a speakerphone. Thus, the appended claims should be construed broadly to include other variants and embodiments of the invention that may be made by those skilled in the art without departing from the scope and range of equivalents of the invention.

What is claimed is:

1. A telephone comprising a base including a plurality of telephone headset connections, each of the headset connections for connecting a telephone headset to the telephone, at least two of the headset connections being capable of simultaneous use in a telephone call.

2. The telephone of claim 1, further comprising a volume control for each of the headset connections, each of the volume controls for selectively adjusting a speaker volume of a telephone headset connected to the volume control's respective headset connection.

3. The telephone of claim 1, further comprising a telephone headset for each of the headset connections.

4. The telephone of claim 3, wherein each of the headsets includes a volume control for selectively adjusting a speaker volume of the headset.

5. The telephone of claim 1, wherein each of the headset connections comprises at least one of a wired connection, a jack connection, and a wireless connection.

6. A telephone comprising:
a base including:
a plurality of telephone handsets; and
a plurality of telephone headset connections, each of the headset connections for connecting a telephone headset to the telephone, at least two of the headset connections being capable of simultaneous use in a telephone call.

7. The telephone of claim 6, wherein the headset connections and the handsets are operatively paired with one another into a plurality of groups, each of the groups including one of the headset connections and one of the handsets.

8. The telephone of claim 6, further comprising a headset volume control for each of the headset connections, each of the headset volume controls for selectively adjusting a speaker volume of a telephone headset connected to the headset volume control's respective headset connection.

9. The telephone of claim 6, further comprising a handset volume control for each of the handsets, each of the handset volume controls for selectively adjusting a speaker volume of the handset volume control's respective handset.

10. The telephone of claim 6, further comprising a telephone headset for each of the headset connections.

11. The telephone of claim 10, wherein each of the headsets includes a volume control for selectively adjusting a speaker volume of the headset.

12. The telephone of claim 6, wherein each of the headset connections comprises at least one of a wired connection, a jack connection, and a wireless connection.

13. The telephone of claim 7, wherein each of the groups includes a switch for automatically deactivating the handset of the group when the headset connection of the group is in use.

14. The telephone of claim 7, wherein each of the groups includes a switch for automatically deactivating the headset connection of the group when the handset of the group is in use.

15. The telephone of claim 6, further comprising a switch for allowing at least one of the plurality of headset connections to independently operate the telephone without the use of any of the plurality of handsets.

16. The telephone of claim 7, further comprising a switch for allowing at least one of the plurality of headset connections to independently operate the telephone without the use of any of the plurality of handsets.

17. A telephone comprising:
a base including:
at least one telephone handset; and
at least one telephone headset connection, the at least one headset connection for connecting a telephone headset to the telephone,
wherein the at least one headset connection and the at least one handset are operatively associated with one another so that the at least one headset connection and the at least one handset are capable of being simultaneously used in a telephone call.

18. A telephone comprising:
a base including:
a plurality of telephone handsets; and
at least one telephone headset connection, the at least one headset connection for connecting a telephone headset to the telephone,
wherein the at least one headset connection and the plurality of handsets are operatively associated with one another so that the at least one headset connection and any one of the plurality of handsets are capable of being simultaneously used in a telephone call.

19. A telephone comprising:
a base including:
a plurality of telephone handsets; and
a plurality of telephone headset connections, each of the headset connections for connecting a telephone headset to the telephone; and
a switching arrangement for allowing one or more of the headset connections and one or more of the handsets to be selected in any combination for simultaneous use in a telephone call.

20. A telephone comprising;
a base;
a plurality of telephone handsets mounted on the base; and
a handset volume control for each of the handsets, each of the handset volume controls for selectively adjusting a speaker volume of the handset volume control's respective handset.
